(19) United States
(12) Patent Application Publication
(10) Pub. No.: US 2002/0003927 A1
(43) Pub. Date: Jan. 10, 2002

(54) Optical device

(75) Inventors: Mitsuaki Tamura, Yokohama-shi (JP); Kazuhito Saito, Yokohama-shi (JP); Tomomi Sano, Yokohama-shi (JP); Ken?apos;ichiro Takahashi, Yokohama-shi (JP)

Correspondence Address: McDERMOTT, WILL & EMERY, 600 13th Street, N.W., Washington, DC, 20005-3096, US

(73) Assignee: Sumitomo Electric Industries, Ltd.

(21) Appl. No.: 09/921,562

(22) Filed: Aug. 6, 2001

(30) Foreign Application Priority Data
Aug. 7, 2000 (JP) 238702/2000

(51) Int. Cl. G02B 6/34

(52) U.S. Cl. 385/37; 385/27; 385/136

(57) ABSTRACT

An object of the present invention is to provide an optical device that can restrain the dependence of the center wavelength of reflection at the diffraction grating upon the voltage applied to the piezoelectric element from shifting depending on the temperature. An embodiment of the optical device has the following structure.

Optical device 1 has a U-shaped member 2, an optical fiber 4 having a diffraction grating portion 8 formed therein and a piezoelectric element (PZT based ceramics) 6. The U-shaped member 2 has a bottom portion 2a and a pair of arm portions 2b and 2c extending from the bottom portion 2a The U-shaped member consists of a material (aluminum alloy or the like) having a thermal expansion coefficient greater than the piezoelectric element 6. A voltage applying means 10 for applying a voltage is connected to the piezoelectric element 6, and the amount of displacement of the piezoelectric element 6 changes according to the magnitude of the applied voltage. The piezoelectric element 6 is in the form of a rod and is fixed to the U-shaped member 2 so as to be connected to the respective intermediate points of the arm portions 2b and 2c. The ends of the arm portions 2b and 2c of the U-shaped member 2 are fixed to the optical fiber 4 in such a manner as to stride the diffraction grating portion 8 formed in the optical fiber.

### BACKGROUND OF THE INVENTION

1. Field of the Invention

The present invention relates to an optical device equipped with an optical fiber having a given length of diffraction grating along its optical axis.

2. Description of the Background

A known example of this kind of optical device is the optical device disclosed in the gazette of Japanese Patent Application Laid-Open No. 10-206753. The optical device disclosed in Japanese Patent Application Laid-Open No. 10-206753 has an optical fiber having a grating portion (diffraction grating) and a piezoelectric element that affords a stress to the grating portion. The ends of the piezoelectric element are mechanically secured to both ends of the grating portion through blocks. Applying a voltage to the piezoelectric element causes a displacement of the piezoelectric element in the longitudinal direction, and this displacement is transferred to the grating portion through the blocks. It is possible to alter the displacement of the piezoelectric element by changing the applied voltage. Therefore, if the displacement of longitudinal direction caused to the piezoelectric element due to the applied voltage is transferred to the grating portion through the blocks, the center wavelength of reflection at the grating portion can be changed.

However, there is the following problem in the optical device of the above structure. In the diffraction grating, because the optical fiber has a positive thermal expansion coefficient, the optical fiber expands or shrinks according to the variation of the ambient temperature, thereby causing the grating pitch to change. Also, the refractive index in the glass portion of the optical fiber changes according to the variation of temperature. As a result, the center wavelength of reflection at the diffraction grating has temperature dependence. If the center wavelength of reflection at the diffraction grating has temperature dependence, there occurs a phenomenon in which the dependence of the center wavelength of reflection at the diffraction grating upon the voltage applied to the piezoelectric element shifts to the long wavelength side or the short wavelength side, depending on the temperature as shown in FIG. 10. For example, the characteristic A exhibited at 20° C. is shifted to the long wavelength side as the characteristic B at 70° C. by the expansion of the piezoelectric element. On the other hand, at −20° C., it is shifted to the short wavelength side as the characteristic C by the shrinkage of the piezoelectric element.

### SUMMARY OF THE INVENTION

In view of the above-mentioned problem the present invention is made for the purpose of providing an optical device that can restrain the dependence of the center wavelength of reflection at the diffraction grating upon the voltage applied to the piezoelectric element from being shifted by the variation of temperature. The optical device according to the present invention is obtained by combining various materials having a suitable thermal expansion coefficient.

An optical device according to a first embodiment of the present invention comprises an optical fiber having a given length of diffraction grating formed in the direction of the optical axis, a rod-shaped piezoelectric element, a means for applying voltage on the piezoelectric element, and a U-shaped member having a pair of arm portions. The optical fiber is fixed to a pair of ends of the arm portions such that the diffraction grating of the optical fiber is positioned between the pair of ends of the arm portions. The piezoelectric element is fixed to the U-shaped member such that the piezoelectric element is connected to the pair of arm portions at their intermediate points. The U-shaped member is made of a material having a thermal expansion coefficient that is larger than that of the piezoelectric element.

In the optical device according to the first embodiment of the present invention, since the U-shaped member is made of a material having a thermal expansion coefficient that is larger than that of the piezoelectric element, the shrinkage amount of the bottom portion of the U-shaped member is larger than the shrinkage amount of the piezoelectric element at low temperature. Consequently, the interval between the ends of the arm portions of the U-shaped member expands because the points where the piezoelectric element is fixed perform as a fulcrum. On the other hand, the expansion amount of the bottom portion of the U-shaped member is larger than the expansion amount of the piezoelectric element at high temperature. Consequently, the interval between the ends of the arm portions of the U-shaped member narrows because the points where the piezoelectric element is fixed perform as a fulcrum. Thus, the interval between the ends of the arm portions of the U-shaped member changes as if the U-shaped member had a negative thermal expansion coefficient. As a result, it is possible to restrain the dependence of the center wavelength of reflection at the diffraction grating upon the voltage applied to the piezoelectric element from being shifted to the long wavelength side or the short wavelength side depending on the temperatures. Also, the displacement caused to the piezoelectric element can be transferred to the diffraction grating after being enlarged by the U-shaped member.

Preferably, the U-shaped member is made of stainless steel. The stainless steel is suitable for transferring the displacement of the piezoelectric element to the diffraction grating efficiently because it has high elasticity and its thermal expansion coefficient is larger than that of the piezoelectric element.

More preferably, the U-shaped member is made of aluminum alloy. Since the thermal expansion coefficient of aluminum alloy is far larger than that of the piezoelectric element, the displacement of the piezoelectric element can be more efficiently transferred to the diffraction grating, and the optical device can be miniaturized.

An optical device according to a second embodiment of the present invention comprises an optical fiber having a given length of diffraction grating formed in the direction of the optical axis, a rod-shaped piezoelectric element, a means for applying a voltage to the piezoelectric element, a rod-shaped member, first members constituting a pair of arm parts, and second members adhered to the first members. The optical fiber is fixed to the ends of the pair of arm parts of the first members such that the diffraction grating of the optical fiber is positioned between the ends of the pair of arm parts of the first members. The rod-shaped member is fixed to the other ends (i.e., opposite the ends to which the optical fiber is fixed) of the first members constituting a pair of arm parts such that the rod-shaped member and the pair of arm parts of the first members form a U-shaped member. The piezoelectric element is fixed to the first members such that the piezoelectric element is connected to the pair of arm parts at their intermediate points. The rod-shaped member and the piezoelectric element have a substantially equal thermal expansion coefficient. The second members are made of a material having a thermal expansion coefficient that is larger than that of the first members.

The second members are adhered to the first members longitudinally on the opposite side (i.e., opposite to the side of the first members constituting the pair of arm parts to which the piezoelectric element and the rod-shaped member are fixed). The thermal expansion coefficient of the second members is larger than that of the first members.

In the optical device according to the second embodiment of the present invention, the interval between the ends of the pair of arm parts of the first members where the optical fiber is fixed changes according to the variation of temperature in the following manner.

When the temperature becomes low, the rod-shaped member and the piezoelectric element shrink and tend to narrow the interval of the pair of arm parts of the first members. However, since the second members shrink more than the first members, the first members are transformed into an arc-shape, in which the side where each second member is attached is the inside of the arc. Accordingly, the interval between the ends of the pair of arm parts of the first members is enlarged.

On the other hand, when the temperature becomes high, the rod-shaped member and the piezoelectric element expand and tend to expand the interval of the pair of arm parts of the first members. However, the second members expand more than the first members, and the first members are transformed into an arc-shape, in which the side where each second member is attached is the outside of the arc. Accordingly, the interval between the ends of the pair of arm parts of the first members is narrowed.

As described above, the interval between the ends of the pair of arm parts of the first members changes as if the first members had a negative thermal expansion coefficient. As a result, it is possible to restrain the dependence of the center wavelength of reflection at the diffraction grating upon the voltage applied to the piezoelectric element from being shifted to the long wavelength side or the short wavelength side according to the temperature. Also, the displacement caused to the piezoelectric element can be enlarged and transferred to the diffraction grating by the first members and the rod-shaped member.

Moreover, since the mechanism for enabling the first members to perform as if virtually having a negative thermal expansion coefficient and the mechanism for expanding the displacement of the piezoelectric element are independent of each other, a degree of freedom for setting the variation to be given to the center wavelength of reflection at the grating portion is increased. Consequently, the variable range of the center wavelength of reflection at the grating portion is enlarged.

Preferably, the first members are made of Invar alloy. The thermal expansion coefficient of Invar alloy is low, and a design can be made so that a large amount of warp of the first members may be obtained.

It is also preferable that the first members are made of ceramics. The thermal expansion coefficient of the ceramics is low, and the first members can be designed to exhibit a large amount of warp.

Preferably, the second members are made of aluminum alloy. The thermal expansion coefficient of aluminum alloy is large, and a large amount of warp of the first members can be designed.

The rod-shaped member preferably is made of a piezoelectric element. Since the rod-shaped member is a piezoelectric element, the thermal expansion coefficient of the rod-shaped member is the same as the piezoelectric element.

An optical device according to a third embodiment of the present invention comprises an optical fiber having a given length of diffraction grating formed in the direction of the optical axis, a rod-shaped piezoelectric element, a means for applying a voltage to the piezoelectric element, a rod-shaped member, first members constituting a pair of arm parts, and second members adhered to the first members. The optical fiber is fixed to the ends of the pair of arm parts of the first members such that the diffraction grating of the optical fiber is positioned between the ends of the pair of arm parts of the first members. The rod-shaped member is fixed to the other ends (i.e., opposite the ends to which the optical fiber is fixed) of the first members constituting a pair of arm parts such that the rod-shaped member and the pair of arm parts of the first members constitute a U-shaped member. The piezoelectric element is fixed to the first members such that the piezoelectric element is connected to the pair of arm parts at their intermediate points. The rod-shaped member and the piezoelectric element have a substantially equal thermal expansion coefficient. The second members are adhered to the first members longitudinally on the side of the first members constituting the pair of arm parts to which the piezoelectric element and the rod-shaped member are fixed. The thermal expansion coefficient of the second members is smaller than that of the first members.

In the optical device according to the third embodiment of the present invention, the interval between the ends of the pair of arm parts of the first members where the optical fiber is fixed changes according to the variation of temperature in the following manner.

When the temperature becomes low, the rod-shaped member and the piezoelectric element shrink and tend to narrow the interval of the pair of arm parts of the first members. However, since the first members shrink more than the second members, the first members are transformed into an arc-shape, in which the side where each second member is attached is the outside of the arc. Accordingly, the interval between the ends of the pair of arm parts of the first members is enlarged.

On the other hand, when the temperature becomes high, the rod-shaped member and the piezoelectric element expand and tend to expand the interval of the pair of arm parts of the first members. However, the first members expand more than the second members, and the first members are transformed into an arc-shape, in which the side where each second member is attached is the inside of the arc. Accordingly, the interval between the ends of the pair of arm parts of the first members is narrowed.

As described above, the interval between the ends of the pair of arm parts of the first members changes as if the first members had a negative thermal expansion coefficient. As a result, it is possible to restrain the dependence of the center wavelength of reflection at the diffraction grating upon the voltage applied to the piezoelectric element from being shifted to the long wavelength side or the short wavelength side according to the variation of temperature. Also, the displacement caused to the piezoelectric element can be enlarged and transferred to the diffraction grating by the first members and the rod-shaped member.

Moreover, since the mechanism for enabling the first members to perform as if virtually having a negative thermal expansion coefficient and the mechanism for expanding the displacement of the piezoelectric element are independent of each other, a degree of freedom for setting the variation to be given to the center wavelength of reflection at the grating portion is increased. Consequently, the variable range of the center wavelength of reflection at the grating portion is enlarged.

### BRIEF DESCRIPTION OF THE DRAWINGS

FIG. 1 is a schematic diagram showing an optical device according to the first embodiment of the present invention.

FIG. 2 illustrates the influence of temperature on the optical device according to the first embodiment of the present invention.

FIG. 2(a) shows a condition at low temperature, and

FIG. 2(b) shows a condition at high temperature.

FIG. 3 illustrates a state in which the displacement of the piezoelectric element is enlarged and transferred to the diffraction grating by the U-shaped member in the optical device according to the first embodiment of the present invention.

FIG. 4 illustrates the operation of the optical device according to the first embodiment of the present invention. FIG. 4(a) shows the condition in which no voltage is applied to the piezoelectric element at normal temperature.

FIG. 4(b) shows the condition in which no voltage is applied to the piezoelectric element at high temperature.

FIG. 4(c) shows the condition in which a voltage is applied to the piezoelectric element at high temperature.

FIG. 5 is a chart showing the dependence of the center wavelength of reflection at a diffraction grating upon the voltage applied to the piezoelectric element in the optical device according to the first embodiment of the present invention.

FIG. 6 is a schematic diagram showing an optical device according to the second embodiment of the present invention.

FIG. 7 illustrates the influence of temperature on the optical device according to the second embodiment of the present invention.

FIG. 7(a) shows a condition at low temperature, and

FIG. 7(b) shows a condition at high temperature.

FIG. 8 illustrates a state in which the displacement of the piezoelectric element is enlarged and transferred to the diffraction grating in the optical device according to the second embodiment of the present invention.

FIG. 9 illustrates the operation of the optical device according to the second embodiment of the present invention.

FIG. 9(a) shows a condition in which no voltage is applied to the piezoelectric element at normal temperature.

FIG. 9(b) shows a condition in which no voltage is applied to the piezoelectric element at high temperature, and

FIG. 9(c) shows a condition in which a voltage is applied to the piezoelectric element at high temperature.

FIG. 10 is a chart showing a state where the dependence of the center wavelength of reflection at a diffraction grating upon the voltage applied to the piezoelectric element is shifted by the variation of temperature in a conventional optical device.

### DETAILED DESCRIPTION

In the following, the preferred embodiments of the optical device according to the present invention will be explained in detail. With reference to the accompanying drawings, the same reference marks denote the same parts, where possible, throughout the drawings, and a repeated explanation will be omitted. The dimensions in the drawings are partly exaggerated and do not always correspond to actual ratios of dimensions.

The embodiments according to the respective embodiments of the present invention are shown in the case of application to a wavelength-variable optical device that is used for taking out a light signal having a specific wavelength selectively from wavelength-division multiplexed light signals in a multiplexed optical network, for example.

(First Embodiment)

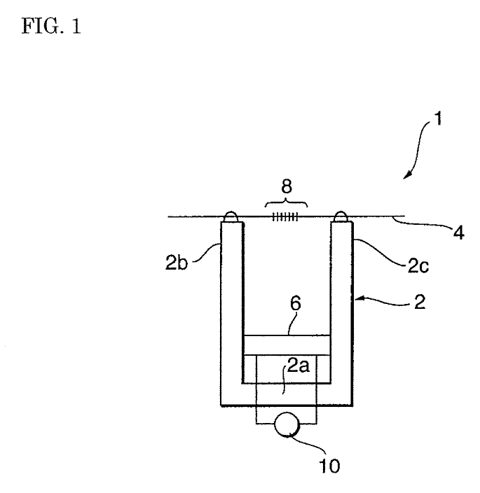

FIG. 1 is a schematic diagram showing an optical device according to the first embodiment of the present invention. The optical device 1 comprises a U-shaped member 2, an optical fiber 4 having a diffraction grating portion 8, and a piezoelectric element 6. The U-shaped member 2 includes a bottom portion 2a and a pair of arm portions 2b and 2c extending from the bottom portion to the optical fiber 4. The U-shaped member 2 is made of material having a larger thermal expansion coefficient than that of the piezoelectric element 6, such as stainless steel or aluminum alloy. The piezoelectric element 6 can be made of PZT (lead zirconate titanate) based ceramics, barium titanate based ceramics, lead titanate based ceramics, or the like.

The piezoelectric element 6 is connected to a means 10 for applying a voltage to the piezoelectric element 6 (hereinafter occasionally, such means is referred to as a “voltage applying means”). The piezoelectric element 6 changes in the amount of its displacement according to the magnitude of voltage applied by the voltage applying means 10. The piezoelectric element 6 is formed in a rod-shape, and the ends of the piezoelectric element are fixed to the U-shaped member 2 at the intermediate points of the pair of arm portions 2b and 2c, respectively. Such fixation on the U-shaped member 2 of piezoelectric element 6 is achieved by using a method such as adhesion, weld, screw, caulking, or the like.

The ends of the arm portions 2b and 2c of the U-shaped member 2 are fixed to the optical fiber 4 such that the diffraction grating portion 8 of the optical fiber 4 is positioned between the ends of the arm portions of the U-shaped member 2 as if the ends of the arm portions stride the diffraction grating portion. The diffraction grating portion 8 of the optical fiber 4 is formed along the direction of the optical axis of the optical fiber 4 such that at least the refractive index of the core portion changes. The diffraction grating portion 8 can be formed, for example, by irradiating ultraviolet rays to the core portion where a cladding portion is exposed by removing a given length of a covering layer provided around the cladding portion. The diffraction grating portion 8 also can be formed without removing the covering layer around the cladding layer. The irradiation of the ultraviolet rays is performed by a known holographic method or phase grating method or the like.

The optical fiber 4 is fixed by adhesion with an adhesive to a pair of the ends 2b and 2c of the arm portions of the U-shaped member 2. Specifically, the optical fiber 4 is fixed with an adhesive at both sides of the diffraction grating portion 8 to the ends of the arm portions 2b and 2c in a state such that a predetermined tension is given to the diffraction grating portion 8 while the center wavelength of diffraction grating portion 8 is monitored. When the optical fiber 4 is fixed in this manner, the diffraction grating portion 8 of the optical fiber 4 and the U-shaped member 2 are heated to a predetermined temperature: a hardening temperature when the adhesive is a heat curable resin, and when the adhesive is an ultraviolet ray curable resin, a temperature at which the viscosity of the resin becomes sufficiently low to give good wettability to the resin. By fitting the optical fiber 4 to the U-shaped member 2 in this way, the tension applied to the optical fiber 4 is maintained at a suitable value in a operating temperature range (−45° C. to 80° C.) of the optical device 1. Consequently, it is possible to maintain the stability of the center wavelength of reflection against the temperature variation at the diffraction grating portion 8.

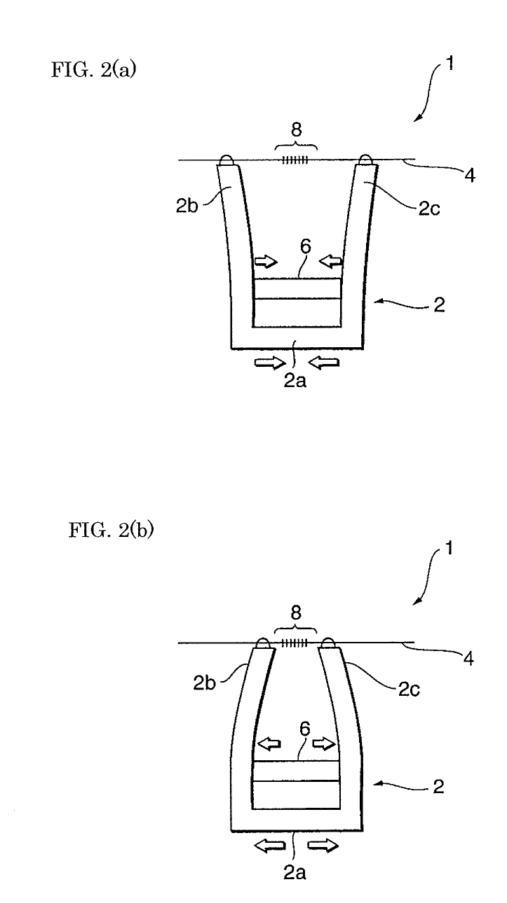

In the optical device 1 having the above-mentioned structure, since the U-shaped member 2 is made of material having a thermal expansion coefficient which is larger than the piezoelectric element 6, at a low temperature (e.g., 20° C.) the amount of shrinkage of the bottom portion 2a of the U-shaped member 2 is larger than that of the piezoelectric element 6 as shown in FIG. 2(a). Consequently, the interval (the distance between the two points, where the optical fiber 4 is fixed at both sides of the diffraction grating portion 8) between the ends of the arm portions 2b and 2c of the U-shaped member 2 expands by the function of a fulcrum at the points where the piezoelectric element 6 is fixed to the U-shaped member 2. On the other hand, at high temperature (e.g., 70° C.) the interval (the distance between the two points, where the optical fiber 4 is fixed at both sides of the diffraction grating portion 8) between the ends of the arm portions 2b and 2c of the U-shaped member 2 narrows by the function of a fulcrum at the points where the piezoelectric element 6 is fixed to the U-shaped member 2. That is because the amount of the expansion of the bottom portion 2a of the U-shaped member 2 is larger than that of the piezoelectric element 6 as shown in FIG. 2(b). The illustration of the voltage applying means 10 is omitted in FIGS. 2(a) and (b).

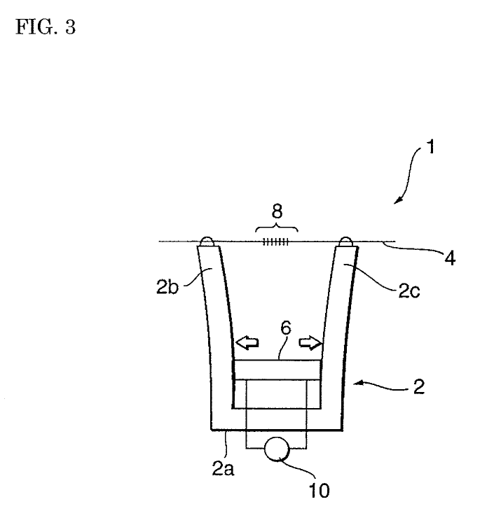

In the optical device 1 having the above-mentioned structure, when a voltage is applied to the piezoelectric element 6 from the voltage applying means 10, a displacement occurs in the longitudinal direction of the piezoelectric element 6 according to the applied voltage, and the displacement is enlarged by the U-shaped member 2 as shown in FIG. 3, and is transferred to the diffraction grating portion 8. The center wavelength of reflection at the diffraction grating portion 8 can, therefore, be varied efficiently according to the magnitude of voltage applied to the piezoelectric element 6.

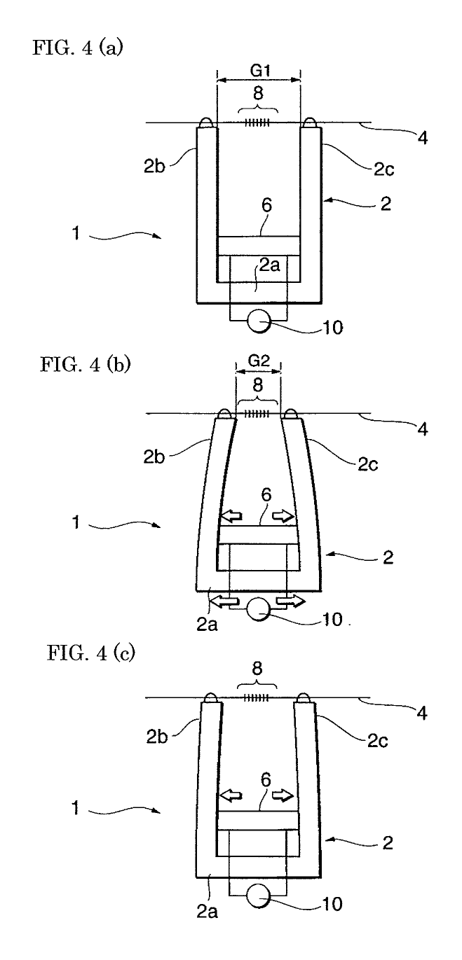

Thus, in the optical device 1, the temperature dependence of the center wavelength of reflection can be substantially eliminated because the tension applied to the optical fiber 4 is decreased, and the center wavelength of reflection at the diffraction grating portion 8 becomes approximately λa (nm) since the interval between the ends 2b and 2c of the arm portions of the U-shaped member 2 narrows to a predetermined value G2 (<G1) as shown in FIG. 4(b) when the ambient temperature of the optical device 1 rises to 70° C., for example, under the condition that the interval between the ends 2b and 2c of the arm portions of the U-shaped member 2 becomes a predetermined value G1 as shown in FIG. 4(a), and the center wavelength of reflection at the diffraction grating portion 8 becomes λa (nm) when no voltage is applied to the piezoelectric element 6 at normal temperature (e.g., 20° C.). Accordingly, under a condition (the condition shown in FIG. 4(c)) in which a voltage is applied to the piezoelectric element 6, the interval between the ends 2b and 2c of the arm portions of the U-shaped member 2 changes only to an extent that corresponds to the displacement of the piezoelectric element 6, and the center wavelength of reflection at the diffraction grating portion 8 changes only to an extent (Δλ) that corresponds to the applied voltage and becomes λa+Δλ(nm).

Also, the temperature dependence of the center wavelength of reflection can be substantially eliminated because the tension applied to the optical fiber 4 is increased, and the center wavelength of reflection at the diffraction grating portion 8 becomes approximately λa (nm) since the interval between the ends 2b and 2c of the arm portions of the U-shaped member 2 expands as described above when the ambient temperature of the optical device 1 decreases to −20° C. from a normal temperature (e.g., 20° C.) under the condition that no voltage is applied to the piezoelectric element 6. Accordingly, under the condition in which a voltage is applied to the piezoelectric element 6, the interval between the ends 2b and 2c of the arm portions of the U-shaped member 2 changes only to an extent that corresponds to the displacement of the piezoelectric element 6, and the center wavelength of reflection at the diffraction grating portion 8 changes only to an extent (Δλ) that corresponds to the applied voltage and becomes λa+Δλ(nm).

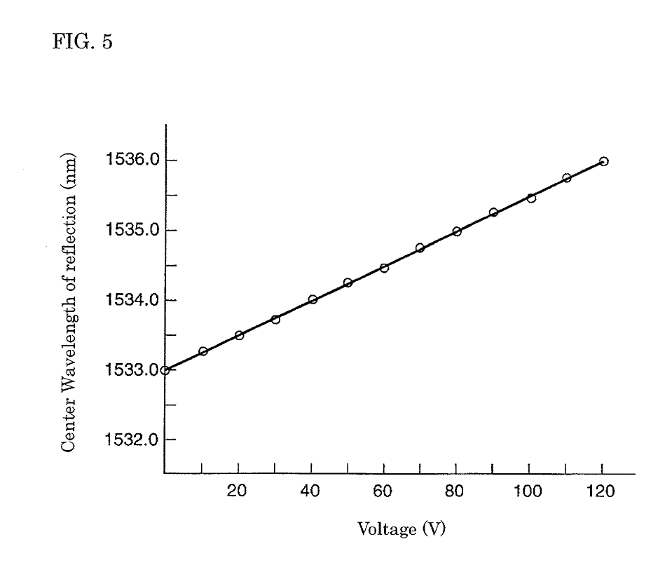

As described above, in the optical device 1 of the present embodiment, the interval between the ends 2b and 2c of the arm portions of the U-shaped member 2 changes as if the U-shaped member 2 apparently had a negative thermal expansion coefficient. As a result, it is possible to restrain the dependence of the center wavelength of reflection at the diffraction grating portion 8 upon the voltage applied to the piezoelectric element from shifting to the long wavelength side or the short wavelength side according to the variation of temperature as shown in FIG. 5. FIG. 5 shows an example in which the center wavelength of reflection at the diffraction grating portion 8 is designed to be 1533.0 nm when the applied voltage is 0 V, and the center wavelength of reflection at the diffraction grating portion 8 changes to 1536.0 nm as the applied voltage is altered to 120 V.

In the case where the U-shaped member 2 is made of stainless steel, the displacement of the U-shaped member 2 can be transferred efficiently to the diffraction grating portion 8 because the stainless steel has a high elasticity as well as a larger thermal expansion coefficient than that of the piezoelectric element.

Furthermore, when the U-shaped member 2 is made of aluminum alloy, the displacement can be more efficiently transferred to the diffraction grating portion 8 and the size of the optical device 1 as a whole can be reduced because the thermal expansion coefficient of aluminum alloy is far larger than that of the piezoelectric element 6.

(Second Embodiment)

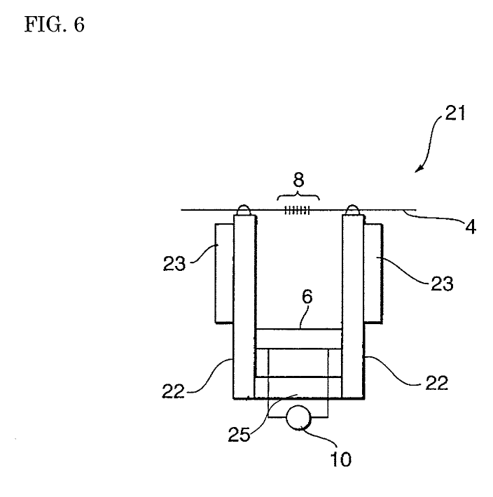

FIG. 6 is a schematic diagram showing the optical device according to the second embodiment of the present invention. An optical device 21 comprises a pair of first members 22, second members 23, an optical fiber 4 having the diffraction grating portion 8, a piezoelectric element 6, and a rod-shaped member 25.

The first members 22 are made of a material having a given thermal expansion coefficient, for example, Invar alloy or ceramics. The first members 22 are fixed to both ends of the piezoelectric element 6 and the ends of the rod-shaped member 25 in a state in which piezoelectric element 6 and the rod-shaped member 25 are disposed in parallel. The respective fixation of the piezoelectric element 6 and the rod-shaped member 25 to the first members 22 is done by adhesion, welding, screwing, caulking, etc.

The second members 23 are made of a material such as aluminum alloy having a larger thermal expansion coefficient than that of the first members 22. The second members 23 are adhered onto the side (outside) opposite the side of the first members 22 to which the piezoelectric element 6 and the rod-shaped member 25 are fixed. Each of the first members 22 and each of the second members 23 are secured together by adhesion, welding, etc.

The rod-shaped member 25 is a piezoelectric element that is the same as the piezoelectric element 6. The piezoelectric element 6 is connected to a voltage applying means 10 that applies a voltage thereon, but no voltage applying means is connected to the rod-shaped member 25. Since a piezoelectric element is employed as the rod-shaped member 25, the thermal expansion coefficient of the rod-shaped member 25 easily can be set equal to the thermal expansion coefficient of the piezoelectric element 6.

The optical fiber 4 is adhered to the ends of the first members 22 with an adhesive. Specifically, the optical fiber 4 is fixed with an adhesive at both sides of the diffraction grating portion 8 to one end of the respective first members 22 in a state such that a predetermined tension is given to the diffraction grating portion 8 while the center wavelength of diffraction grating portion 8 is monitored. When the optical fiber 4 is fixed in this manner, the first members 22 and the diffraction grating portion 8 of the optical fiber 4 are heated to a predetermined temperature: a curing temperature when the adhesive is a heat-curable resin, and when the adhesive is an ultraviolet ray curable resin, a temperature at which the viscosity of the resin becomes sufficiently low to give good wettability to the resin. By fitting the optical fiber 4 to the first members 22 in this way, the tension applied to the optical fiber 4 is maintained at a suitable value in a operating temperature range (−45° C. to 80° C.) of the optical device 1. Consequently, it is possible to maintain the stability of the center wavelength of reflection against the temperature variation at the diffraction grating portion 8.

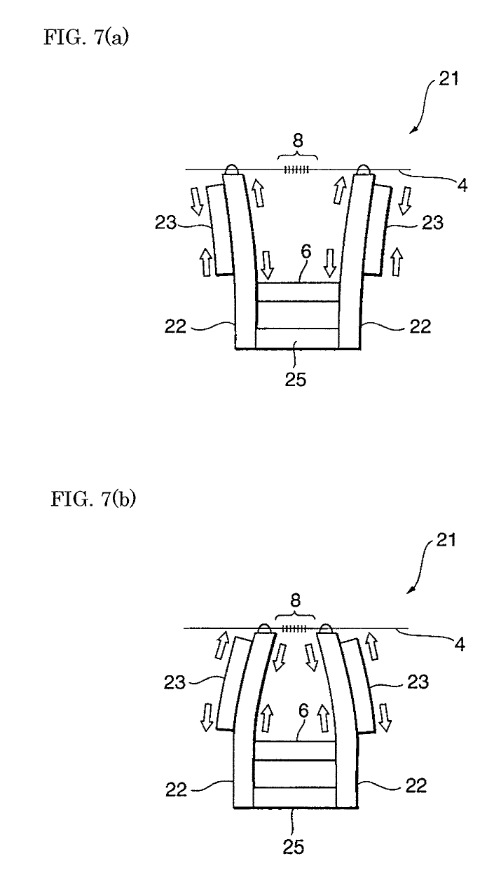

In the optical device 21 having the above-mentioned structure, since the second members 23 are made of a material having a thermal expansion coefficient larger than that of the first members 22, each first member 22 and each second member 23 form a so-called bimetal structure, and consequently the first members 22 warp to a predetermined direction according to the variation of temperature. As shown in FIG. 7(a), at a low temperature (e.g., 20° C.) the piezoelectric element 6 and the rod-shaped member 25 shrink similarly and tend to narrow the interval between the first members 22. However, the first members 22 warp toward the outside (the side to which each second member 23 is adhered), and accordingly the interval between the ends of the first members 22 (i.e., the distance between the two points, where the optical fiber 4 is fixed at both sides of the diffraction grating portion 8) expands.

On the other hand, at a high temperature (e.g., 70° C.) the interval (the distance between the two points, where the optical fiber 4 is fixed at both sides of the diffraction grating portion 8) between the ends of the first members 22 narrows because, as shown in FIG. 7(b), the first members 22 warp toward the inner side (which is opposite the side on which each second member 23 is fixed), although the piezoelectric element 6 and the rod-shaped member 25 expand similarly and tend to expand the interval of the first members 22. The illustration of the voltage applying means 10 is omitted in FIGS. 7(a) and (b).

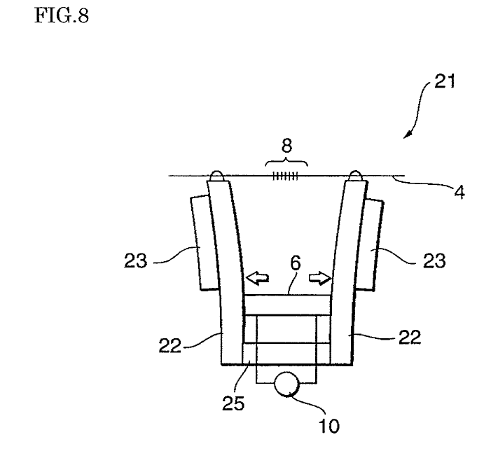

In the optical device 21 having the above-mentioned structure, when a voltage is applied to the piezoelectric element 6 from the voltage applying means 10, a displacement occurs in the longitudinal direction of the piezoelectric element 6 according to the applied voltage, and the displacement is enlarged by the first members 22 as shown in FIG. 8, and is transferred to the diffraction grating portion 8. Therefore, the center wavelength of reflection at the diffraction grating portion 8 can be varied efficiently according to the magnitude of voltage applied to the piezoelectric element 6.

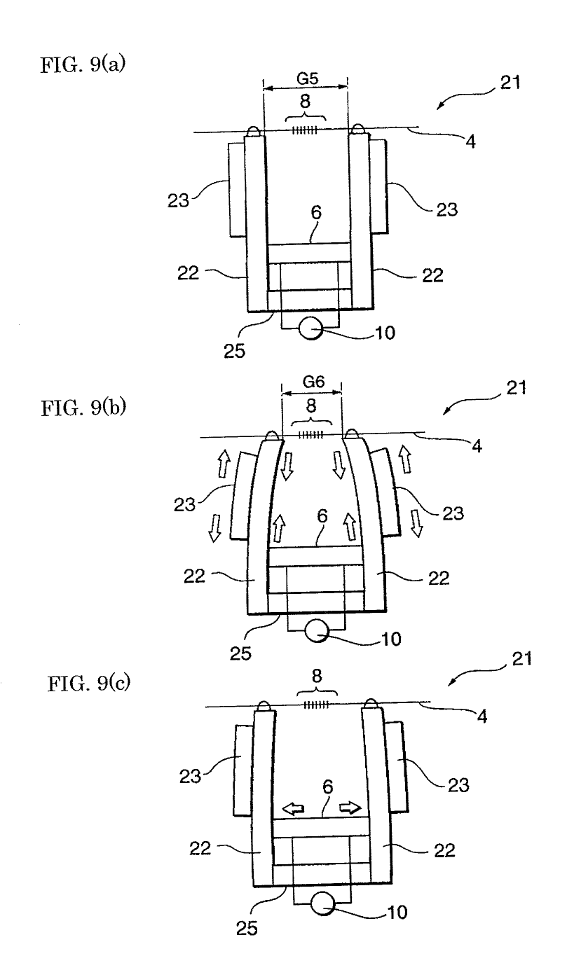

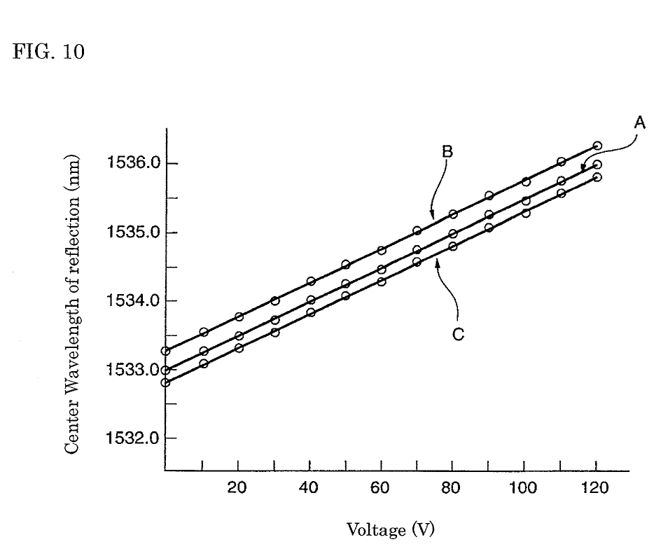

Thus, in the optical device 21, the temperature dependence of the center wavelength of reflection can be substantially eliminated because the tension applied to the optical fiber 4 is decreased, and the center wavelength of reflection at the diffraction grating portion 8 becomes approximately λb (nm) since the interval between the ends of the first members 22 narrows to a predetermined value G6 (<G5) as shown in FIG. 9(b) when the ambient temperature of the optical device 21 rises to 70° C., for example, under the condition that the interval between the ends of the first members 22 becomes a predetermined value G5 as shown in FIG. 9(a), and the center wavelength of reflection at the diffraction grating portion 8 becomes λb (nm) when no voltage is applied to the piezoelectric element 6 at normal temperature (e.g., 20° C.). Accordingly, under a condition (the condition shown in FIG. 9(c)) in which a voltage is applied to the piezoelectric element 6, the interval between the ends of the first members 22 changes only to an extent that corresponds to the displacement of the piezoelectric element 6, and the center wavelength of reflection at the diffraction grating portion 8 changes only to an extent (Δλ) that corresponds to the applied voltage and becomes λb+Δλ(nm).

Also, the temperature dependence of the center wavelength of reflection can be substantially eliminated because the tension applied to the optical fiber 4 is increased, and the center wavelength of reflection at the diffraction grating portion 8 becomes approximately λb (nm) since the interval between the ends of the first members 22 expands as described above when the ambient temperature of the optical device 21 decreases to −20° C. from a normal temperature (e.g., 20° C.) under the condition that no voltage is applied to the piezoelectric element 6. Accordingly, under the condition in which a voltage is applied to the piezoelectric element 6, the interval between the ends of the first members 22 changes only to an extent that corresponds to the displacement of the piezoelectric element 6, and the center wavelength of reflection at the diffraction grating portion 8 changes only to an extent (Δλ) that corresponds to the applied voltage and becomes λb+Δλ(nm).

As described above, in the optical device 21 of the present embodiment, the interval between the ends of the first members 22 changes as if the first members 22 apparently had a negative thermal expansion coefficient, and hence, as in the case of the first embodiment, it is possible to restrain the dependence of the center wavelength of reflection at the diffraction grating portion 8 upon the voltage applied to the piezoelectric element from shifting to the long wavelength side or the short wavelength side according to the variation of temperature. In the optical device 21 since the mechanism for generating a negative thermal expansion coefficient by the first members 22 and the second members 23 and the mechanism for expanding the displacement of the piezoelectric element are independent of each other, it is possible to set a large amount of wavelength shift.

When the first members 22 are made of Invar alloy, a design can be made such that the first members exhibit a large amount of warp because the thermal expansion coefficient of Invar alloy is low. Also, when the first members 22 are made of ceramics, the first members can be designed to exhibit a large amount of warp because the thermal expansion coefficient of the ceramics is low. When the second members 23 are made of aluminum alloy, a large amount of warp of the first members can be designed because the thermal expansion coefficient of aluminum alloy is high.

(Third Embodiment)

An optical device according to the third embodiment of the present invention comprises an optical fiber having a diffraction grating portion formed in a given length along the optical axis thereof, a rod-shaped piezoelectric element, a voltage applying means for applying a voltage to the rod-shaped pie zoelectric element, a rod-shaped member, first members forming a pair of arm parts, and second members adhered to the first members. The optical fiber is fixed to an end of the respective arm parts of the first members in a manner that the diffraction grating portion of the optical fiber is positioned between the ends of the arm parts of the first members as if the ends of the arm parts stride the diffraction grating portion. The rod-shaped member is fixed to the other ends (i.e., opposite the ends to which the optical fiber is fixed) of the first members constituting the pair of arm parts such that the rod-shaped member and the pair of arm parts of the first members form a U-shaped member. The piezoelectric element is fixed to the arm parts of the first members such that the piezoelectric element is connected to the intermediate points of the arm parts. The rod-shaped member and the piezoelectric element have a substantially equal thermal expansion coefficient. The second members are adhered to the arm parts of the first members longitudinally on the side to which the piezoelectric element and the rod-shaped member are fixed. The second members are made of a material having a thermal expansion coefficient that is lower than that of the first members. The first members can be made of aluminum and the second members can be made of negative thermal expansion material such as glass-ceramics (β-eucryptite).

In the optical device according to the third embodiment of the present invention, the interval between the ends of the pair of arm parts of the first members where the optical fiber is fixed changes according to the variation of temperature in the following manner.

When the temperature becomes low, the rod-shaped member and the piezoelectric element shrink and tend to narrow the interval of the pair of arm parts of the first members. However, since the first members shrink more than the second members, the first members are transformed into an arc-shape, in which the side where each second member is attached is the outside of the arc. Accordingly, the interval between the ends of the pair of arm parts of the first members is enlarged.

On the other hand, when the temperature becomes high, the rod-shaped member and the piezoelectric element expand and tend to expand the interval of the pair of arm parts of the first members. However, the first members expand more than the second members, and the first members are transformed into an arc-shape, in which the side where each second member is attached is the inside of the arc. Accordingly, the interval between the ends of the pair of arm parts of the first members is narrowed.

As described above, the interval between the ends of the pair of arm parts of the first members changes as if the first members apparently had a negative thermal expansion coefficient. As a result, it is possible to restrain the dependence of the center wavelength of reflection at the diffraction grating upon the voltage applied to the piezoelectric element from being shifted to the long wavelength side or the short wavelength side according to the variation of temperature. Also, the displacement caused to the piezoelectric element can be enlarged and transferred to the diffraction grating by the first members and the rod-shaped member.

Moreover, since the mechanism for enabling the first members to behave as if virtually they had a negative thermal expansion coefficient and the mechanism for enlarging the displacement of the piezoelectric element are independent of each other, a degree of freedom is provided for designing the appropriate variation to be given to the center wavelength of reflection at the grating portion.

Although three embodiments of the present invention are described in detail above, the present invention is not limited to them. For example, the rod-shaped member 25, which is a piezoelectric element in the above embodiments, may be a member made of other materials, such as ceramics, nickel copper or glass, having a thermal expansion coefficient equal to the piezoelectric element.

What is claimed is:

1. An optical device comprising:
an optical fiber having a given length of diffraction grating formed in the direction of the optical axis thereof;
a rod-shaped piezoelectric element;
a means for applying a voltage to said piezoelectric element; and
a U-shaped member having a pair of arm portions,
said optical fiber being fixed to a pair of ends of said arm portions such that the diffraction grating of said optical fiber is positioned between the pair of ends of said arm portions as if the ends of said arm portions stride the diffraction grating portion,
said piezoelectric element being fixed to said U-shaped member such that said piezoelectric element is connected to the pair of said arm portions at their intermediate points, and
said U-shaped member being made of a material having a larger thermal expansion coefficient than that of said piezoelectric element.

2. An optical device according to claim 1, wherein said U-shaped member is made of stainless steel.

3. An optical device according to claim 1, wherein said U-shaped member is made of aluminum alloy.

4. An optical device comprising:
an optical fiber having a given length of diffraction grating formed in the direction of the optical axis thereof,
a rod-shaped piezoelectric element,
a means for applying a voltage to said piezoelectric element,
a rod-shaped member,
first members constituting a pair of arm parts, and
second members adhered to said first members;
said optical fiber being fixed to the ends of said pair of arm parts of said first members such that the diffraction grating of said optical fiber is positioned between the ends of said pair of arm parts of said first members, said rod-shaped member being fixed to the other ends (i.e., opposite the ends to which said optical fiber is fixed) of said first members, said rod-shaped member and said pair of arm parts of said first members constituting a U-shaped member, said piezoelectric element being fixed to said first members so as to be connected to said pair of arm parts at their intermediate points, said second members being adhered to the first members longitudinally on the side opposite to the side to which both said piezoelectric element and said rod-shaped member are fixed;
wherein said rod-shaped member and said piezoelectric element have a substantially equal thermal expansion coefficient, and said second members are made of a material having a thermal expansion coefficient that is larger than that of said first members.

5. An optical device according to claim 4, wherein said first members are made of Invar alloy.

6. An optical device according to claim 4, wherein said first members are ceramic.

7. An optical device according to claim 4, wherein said second members are made of aluminum alloy.

8. An optical device according to claim 4, wherein said rod-shaped member is a piezoelectric element.

9. An optical device comprising:
an optical fiber having a given length of diffraction grating formed in the
direction of the optical axis,
a rod-shaped piezoelectric element,
a means for applying a voltage to said piezoelectric element,
a rod-shaped member,
first members constituting a pair of arm parts, and
second members adhered to the first members;
said optical fiber being fixed to the ends of said pair of arm parts of said first members such that the diffraction grating of said optical fiber is positioned between the ends of said pair of arm parts of said first members, said rod-shaped member being fixed to the other ends (i.e., opposite the ends to which said optical fiber is fixed) of said first members, said rod-shaped member and said pair of arm parts of said first members constituting a U-shaped member, said piezoelectric element being fixed to said first members so as to be connected to said pair of arm parts at their intermediate points, said second members being adhered to the first members longitudinally on the side to which both said piezoelectric element and said rod-shaped member are fixed;
wherein said rod-shaped member and said piezoelectric element have a substantially equal thermal expansion coefficient, and said second members are made of a material having a thermal expansion coefficient that is lower than that of said first members.
